(19) United States
(12) Patent Application Publication
(10) Pub. No.: US 2006/0011850 A1
(43) Pub. Date: Jan. 19, 2006

(54) Multilayer polarization sensor (MPS) for x-ray and extreme ultraviolet radiation

(76) Inventor: John F. Seely, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 10/234,257

(22) Filed: Sep. 5, 2002

(51) Int. Cl. G01T 1/24

(52) U.S. Cl. 250/370.01

(57) ABSTRACT

A multilayer polarization sensor (MPS) for measuring the polarization of radiation in the x-ray and extreme UV wavelength regions. The MPS includes a silicon photodiode with a multilayer (e.g. 50 bilayers) interference coating. The interference coating selectively transmits the orthogonal (p) polarization component in the desired wavelength to generate a current. The (s) polarization component is transmitted through a second interference coating to generate another current. The ratio of the difference between the currents to sum of the currents is the measure of polarization of the incident radiation. Radiation outside the desired wavelength can be dispersed out of the incident beam by a transmission or reflection grating.

### FIELD OF THE INVENTION

This invention relates to the measurement of polarization of x-ray and extreme ultraviolet (EUV) radiation. More particularly it relates to a system and method for measuring polarization that can operate over any x-ray and EUV wavelength range where transmissive and reflective multilayer interference coatings can function.

### BACKGROUND OF THE INVENTION

The standard technique for measuring the polarization of x-ray and extreme ultraviolet (EUV) radiation is to measure the intensity of the radiation reflected from a mirror at an angle of incidence of 45 degrees. The mirror reflects the component of the radiation with the electric field vector perpendicular to the plane of incidence, the s polarization component. The orthogonal p polarization component is absorbed by the mirror and is not reflected for measurement. The limitation of this technique is that the reflectance of all materials at 45 degrees incidence is very low in the x-ray and EUV regions and decreases drastically with decreasing wavelength. Thus the 45 degree reflection technique has low sensitivity. In addition, the reflectance is susceptible to surface contamination and oxidation of the mirror that can detrimentally affect the sensitivity and accuracy of the polarization measurement.

### SUMMARY OF THE INVENTION

An object of this invention is to provide a device for measuring the polarization of x-ray and extreme ultraviolet radiation.

Another object of this invention is to provide a polarization measurement device that operates over any x-ray or EUV wavelength range where transmissive and reflective multilayer interference coatings can function.

Another object of this invention is to provide a polarization measurement device that has increased sensitivity in the x-ray region where reflectance is poor.

Another object of this invention is to provide a polarization measurement device using multilayer interference coatings to greatly enhance reflectance and transmittance compared to bilayer absorption coatings.

Another object of this invention is to provide a polarization measurement device in which the polarization efficiency of the MPS is essentially 100% within the wavelength range covered by the multilayer interference coating.

### BRIEF DESCRIPTION OF THE DRAWINGS

FIG. 1 shows a schematic of the multilayer polarization sensor FIG. 2a shows the current of bilayer coatings on photodiodes, the current recorded by the uncoated photodiode.

FIG. 2b shows the transmittance of a coated photodiode with Fe/Al

FIG. 2c shows the transmittance of a coated photodiode with Mn/Al

FIG. 2d shows the transmittance of a coated photodiode with V/Al

FIG. 2e shows the transmittance of a coated photodiode with Ti/C

FIG. 2f shows the transmittance of a coated photodiode with Pd/Ti

FIG. 3a shows the reflectance of a multilayer polarization sensor

FIG. 3b shows the absorptance of a multilayer polarization sensor

FIG. 3c shows the transmittance of a multilayer polarization sensor

FIG. 3d shows the polarization of a multilayer polarization sensor

### DESCRIPTION OF THE PREFERRED EMBODIMENT

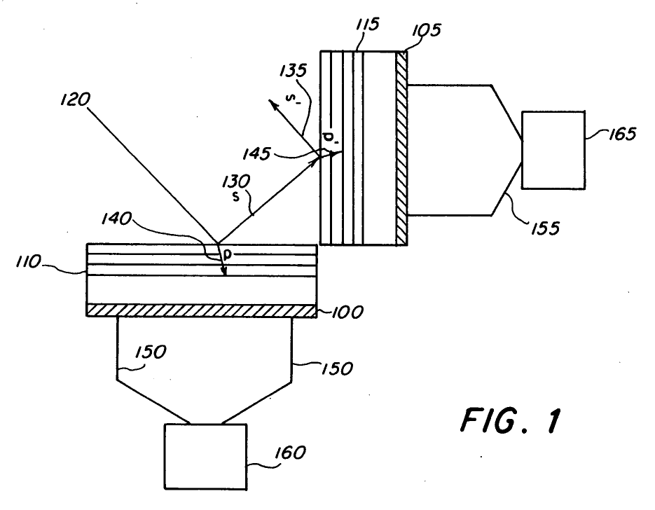

In the preferred embodiment, a multiple layer polarization sensor as shown in FIG. 1 includes a silicon photodiode 100 with a multilayer interference coating 110 and bonding wires leading to two electrodes 150. The silicon photodiode consists of a silicon diode that is sensitive to x-ray and EUV radiation. The multilayer interference coating is deposited onto the surface of the silicon diode using standard vacuum deposition or magnetron sputtering techniques. As x-rays or EUV radiation of less than 0.25 microwatts 120 are directed at the multilayer interference coating 110 at an angle of incidence of approximately 45 degrees, the multilayer interference coating 110 reflects the s polarization component of the incident radiation 130 and transmits the p polarization component 140. As the p polarization component is selectively transmitted through the MIC and is deposited in the underlying silicon photodiode 100, the photodiode generates a current that is recorded by connecting the two electrode pins 150 to a standard current measuring device, e.g. a Keithley Model 617 Electrometer 160 which measures current between 1 pA and 1 microA.

A second multiple layer polarization sensor is also shown in FIG. 1 and includes a silicon photodiode 105 with a multilayer interference coating 115 and bonding wires leading to two electrodes 155. The silicon photodiode consists of a silicon diode that is sensitive to x-ray and EUV radiation. The multilayer interference coating is deposited onto the surface of the silicon diode using standard vacuum deposition or magnetron sputtering techniques. As x-rays or EUV radiation of less than 0.25 microwatts are reflected from the first multilayer interference coating and are directed at the second multilayer interference coating 115 at an angle of incidence of approximately 45 degrees, the multilayer interference coating 115 reflects the s′ polarization component of the incident radiation 135 and transmits the p′ polarization component 145. As the p′ polarization component is selectively transmitted through the MIC and is deposited in the underlying silicon photodiode 105 , the photodiode generates a current that is recorded by connecting the two electrode pins 155 to a second Keithley Model 617 Electrometer 160 which measures current between 1 pA and 1 microA.

The polarization is determined by using the readouts of the two electrometers by dividing the difference in the two readouts by the sum of the two readouts. For example a readout of 10 pA in electrometer 160 and a readout of 5 pA in electrometer 165 would derive the following polarization:
(10−5)/(10+5)=5/15=0.33 or 33 percent p polarization.

In this manner, the one multilayer polarization sensor senses the p polarized incident radiation and a second multilayer polarization sensor senses the s polarized incident radiation.

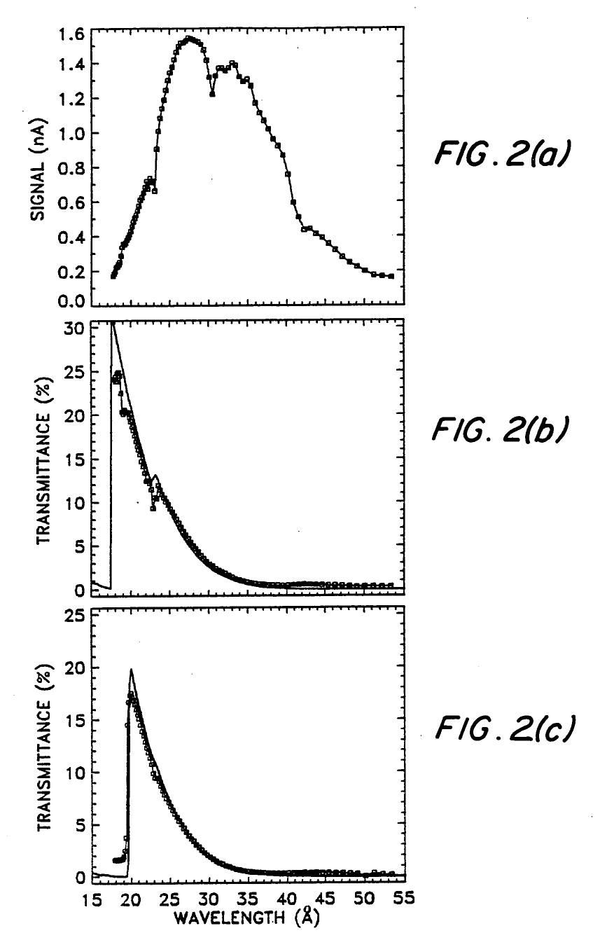

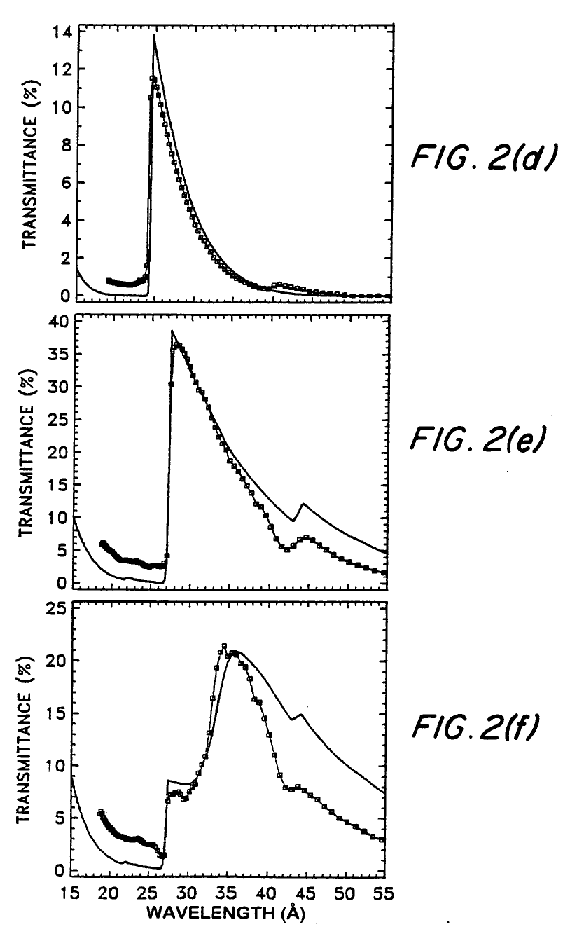

A multiple layer beyond a bilayer coating is the preferred embodiment for this invention since single bilayer coatings shown in FIGS. 2a-2f were not found to be effective. These coatings transmitted both polarization components and therefore had no polarization sensitivity. FIG. 2a shows the transmittances of bilayer coatings on photodiodes, the current recorded by the uncoated photodiode. FIG. 2b shows the transmittance of a coated photodiode with Fe/Al. FIG. 2c shows the transmittance of a coated photodiode with Mn/Al. FIG. 2d shows the transmittance of a coated photodiode with V/Al. FIG. 2e shows the transmittance of a coated photodiode with Ti/C. FIG. 2f shows the transmittance of a coated photodiode with Pd/Ti. The wavelength bandpasses were determined by the absorption of the incident radiations in the layers. In contrast, a mulitple bilayer interference coating has greatly enhanced reflectance and transmittance compared to single bilayer absorption coatings. The thickness of the individual layers has been selected to optimize high reflectance of the undesired polarization component and high transmittance of the desired polarization component. In the preferred embodiment, the thickness of the Mo layers are approximately 2.4 to 3.2 nm and the thickness of the Si layers are approximately 5.8 to 7 nm.

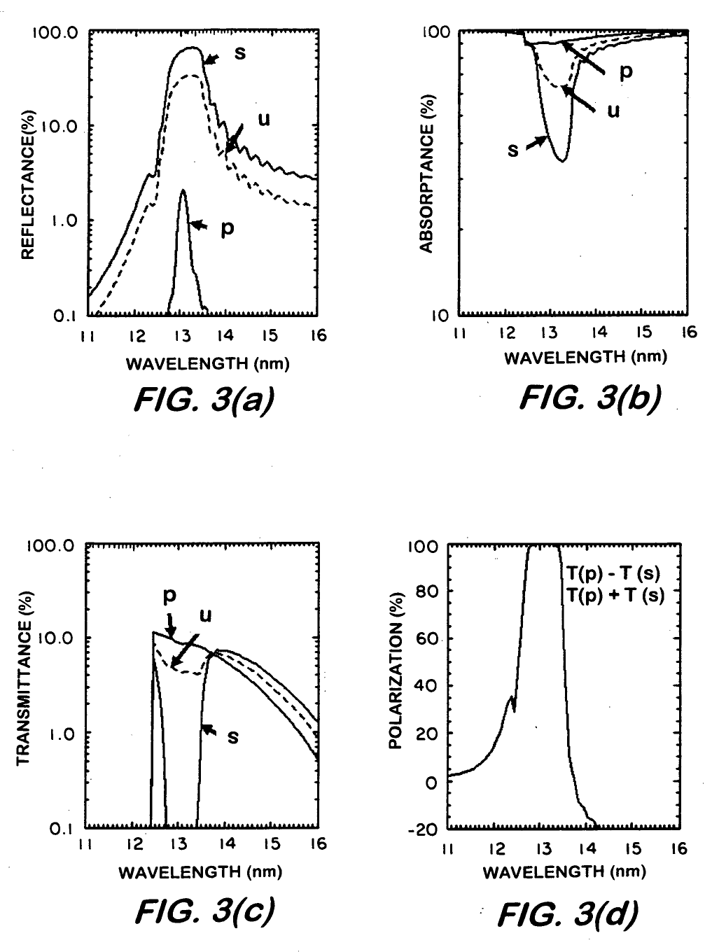

The performance of the multilayer polarization sensor is shown in FIGS. 3a-3d. For the qualities of reflectance, absorption, transmittance, and polarization, the sensor was constructed from 50 bilayers of Mo and Si with layer thicknesses optimized to reflect s polarized radiation at an angle of 45 degrees and a wavelength of 13.2 nm. The graphs of FIGS. 4a-4d show the qualtities for p polarized radiation (p), s polarized radiation (s), and unpolarized radiation (u). The number of bilayers has to be large enough to reflect the unmeasured polarization and small enough to transmit the desired polarization. The reflectance of the s component and p component are shown in FIG. 3a. The absorptance of the s component and p component are shown in FIG. 3b. The transmittance of the s and p components is shown in FIG. 3c. As shown in FIG. 3d, the polarization efficiency of the multilayer polarization sensor is essentially 100% within the wavelength range covered by the multilayer polarization sensor, at wavelength 13.2 nm the polarization graph is 100%.

For wavelengths greater than 13.2 nm and less than 100 nm, the absorption is higher and the number of bilayers required is smaller so that 20 bilayers will be preferable. For wavelengths less than 13.2 nm and greater than 12.5 nm, absorption is lower and the number of bilayers required is greater so that 60 bilayers will be preferable. Because the polarization performance is lower outside the wavelength range covered by the multilayer polarization sensor, the radiation must be dispersed so that only wavelengths within the multilayer interference coating coverage are incident on the multilayer polarization sensor. This dispersion of radiation may be accomplished by using a transmission or reflection grating. Transmission gratings are routinely used to disperse EUV and x-ray radiation from laboratory, solar, and astrophysical radiation sources.

An advantage of the multilayer polarization sensor is that this device operates in transmission with performance that is greatly enhanced by the multilayer interference coating. In addition the performance of the multilayer polarization sensor is less susceptible to surface contamination and oxidation because the transmission of the p polarization component, the sensed conponent, is a bulk process rather than a surface process as is reflection.

The present invention as tested in FIGS. 3a-3d has been evaluated over the wavelength range of 3 nm to 100 nm. The preferred embodiment for multilayer materials includes Mo and Si, but may also include other material combinations in common usage such as W/C, W/B₄C, Ir/Si, Sc/Si, Mo/Be, and Mo/Y.

Although this invention has been described in relation to an exemplary embodiment thereof, it will be understood by those skilled in the art that still other variations and modifications can be affected in the preferred embodiment without detracting from the scope and spirit of the invention as described in the claims:

What is claimed:

1. A multple layer polarization sensor comprising:
a photodiode connected to a multiple layer coating with thickness greater than one bilayer;
said multiple layer coating preferentially transmitting a polarization component of incident radiation;
said photodiode receiving said polarization component to generate an electric current;
electrode contacts connected to said photodiode for transmitting said electric current to a meter for measuring current generated by said polarization component.

2. The multiple layer polarization sensor as in claim 1, wherein the photodiode is a silicon photodiode.

3. The multiple layer polarization sensor as in claim 1, wherein the multiple layer coating is a multilayer interference coating.

3. The multiple layer polarization sensor as in claim 3, wherein the multilayer interference coating comprises a bilayer selected from the group consisting of Mo/Si, W/C, W/B₄C, Ir/Si, Sc/Si, Mo/Be, and Mo/Y.

4. A method of measuring the polarization of x-ray and extreme ultraviolet radiation comprising the steps of:
directing said radiation at a photodiode with a multiple layer coating with thickness greater than one bilayer;
selectively transmitting a polarized component of said radiation through said multiple layer coating;
depositing the polarized component on said photodiode; and
generating an electric current representative of said polarized component.

5. The method of claim 4, wherein said photodiode is a silicon photodiode.

6. The method of claim 4, wherein said multiple layer coating comprises a bilayer selected from the group consisting of Mo/Si, W/C, W/B₄C, Ir/Si, Sc/Si, Mo/Be, and Mo/Y.

7. A multple layer polarization sensor comprising:
a first photodiode connected to a multiple layer coating with thickness greater than one bilayer;
said multiple layer coating preferentially transmitting a first polarization component of incident radiation;
said first photodiode receiving said polarization component to generate an electric current;
a first meter for receiving said electric current generated by said first photodiode and for measuring said current;
said multiple layer coating preferentially reflecting a second polarization component of said incident radiation;
a second multiple layer coating preferentially transmitting a second polarization component of incident radiation;
a second photodiode receiving said second polarization component to generate an electric current; and
a second meter for receiving said electric current generated by said second photodiode and for measuring said current whereby comparison of currents generated by said first and second meters is a measure of polarization of said incident radiation.
